(19) United States
(12) Patent Application Publication
(10) Pub. No.: US 2004/0249764 A1
(43) Pub. Date: Dec. 9, 2004

(54) Method for verifying the validity of digital franking notes

(76) Inventors: Alexander Delitz, Bonn (DE); Peter Fery, Zwingenberg (DE); Jurgen Helmus, Bonn (DE); Aloysius Hohl, Fulda (DE); Gunther Meier, Reinheim (DE); Elke Robel, Werne (DE); Dieter Stumm, Grossefehn (DE)

Correspondence Address: James P Zeller, Marshall Gerstein & Borun, 6300 Sears Tower, 233 South Wacker Drive, Chicago, IL, 60606-6357, US

(21) Appl. No.: 10/482,748

(22) PCT Filed: Jun. 28, 2002
(86) PCT No.: PCT/DE02/02348

(30) Foreign Application Priority Data
Jul. 1, 2001 (DE) 101312547

(51) Int. Cl. G06F 17/60

(52) U.S. Cl. 705/60

(57) ABSTRACT

The invention relates to a method for verifying the authenticity of a franking note placed on a postal article. According to the invention, cryptographic information contained in the franking note is decoded and used for verifying the authenticity of the franking note. The inventive method is characterized in that the reading unit graphically records the franking note and transmits it to a verification unit and in that the verification unit controls a sequence of partial tests.

It is known practice to provide mail pieces with digital franking marks.

To make it easier for senders of mail pieces to produce the franking marks, the franking system used by Deutsche Post AG, for example, allows franking marks to be produced in a customer system and output to a printer using any interface.

To prevent this method from being misused, the digital franking marks contain cryptographical information, for example about the identity of the customer system controlling the production of the franking mark.

The invention is based on the object of providing a method which can be used to verify the authenticity of the franking marks quickly and reliably. In particular, the method is intended to be suitable for verifying in large-scale use, particularly in mail or freight centers.

The invention achieves this object by virtue of the reading unit graphically recording the franking mark and transmitting it to a verifying unit, and by virtue of the verifying unit controlling a sequence of examination components.

It is particularly expedient for one of the examination components to comprise decryption of the cryptographical information contained in the franking mark.

Integrating the decryption of the cryptographical information into the examination process makes it possible to record the authenticity of the franking marks directly, which means that verifying can be carried out online—particularly while the mail piece is being processed in a processing machine.

Another advantage is that one of the examination components comprises a comparison between the date of production of the franking mark and the current date. Integrating the date of production of the franking mark —particularly in encrypted form—increases the data protection, since the comparison between the date of production of the franking mark and the current date prevents multiple use of a franking mark for delivering mail pieces.

To increase the verifying speed further, it is advantageous that the reading unit and the verifying unit interchange information using a synchronous protocol.

In another, likewise expedient embodiment of the invention, the reading unit and the verifying unit communicate with one another using an asynchronous protocol.

It is particularly expedient in this context that the reading unit sends a data message to the verifying unit.

Preferably, the data message contains the content of the franking mark.

The further advantages, particular features and expedient developments of the invention can be found in the subclaims and in the subsequent illustration of preferred exemplary embodiments with reference to the drawings.

In the drawings,

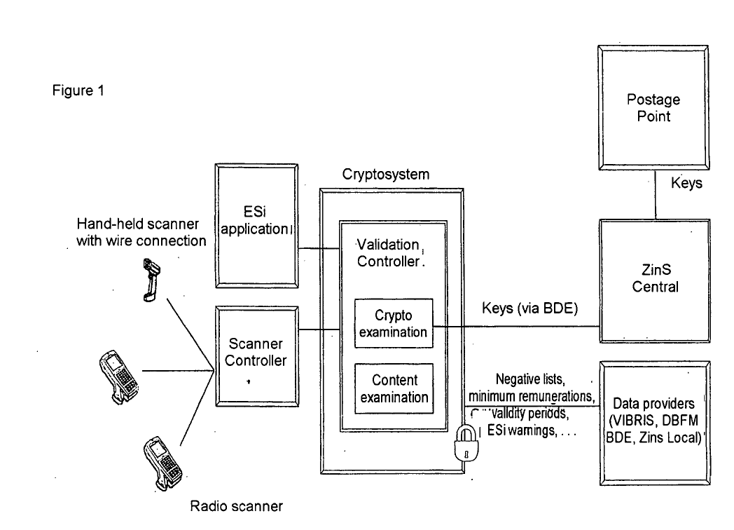

FIG. 1 shows a basic illustration of system components in a remuneration protection system;

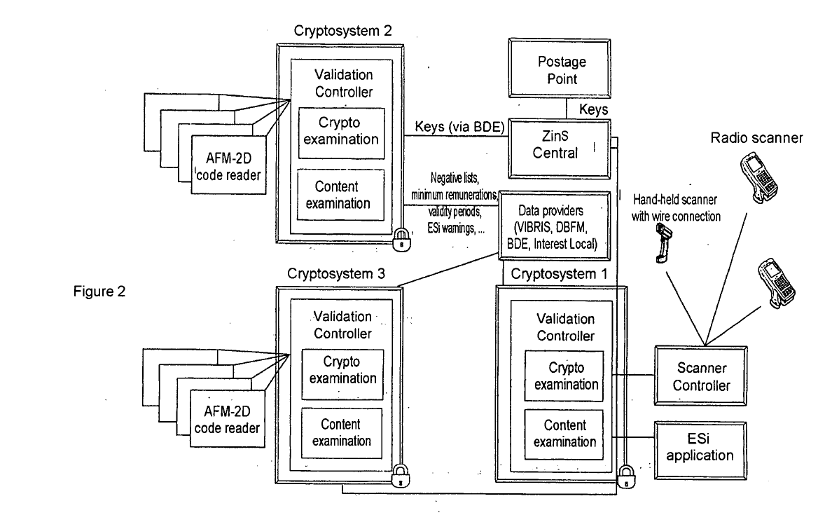

FIG. 2 shows a particularly preferred embodiment of the remuneration protection system, hand-held scanner and remuneration protection PC);

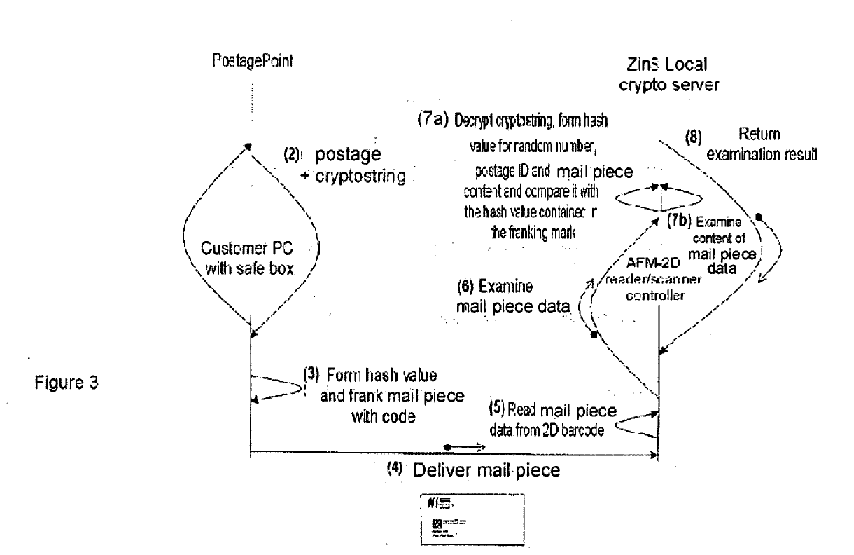

FIG. 3 shows a basic illustration of production and verifying of franking marks;.

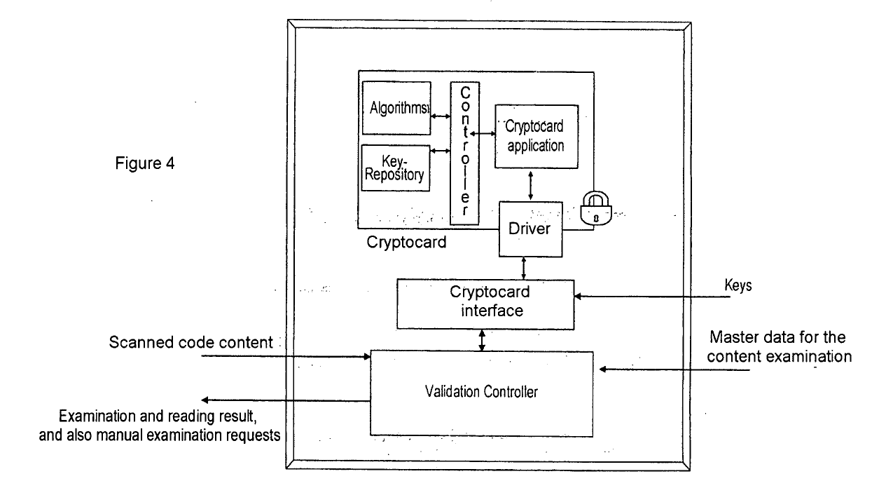

FIG. 4 shows an overview of components in the crypto system;

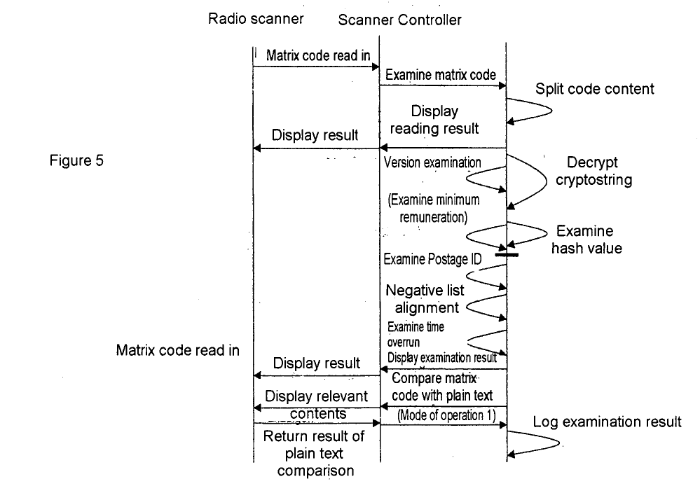

FIG. 5 shows a preferred implementation of the verifying method;

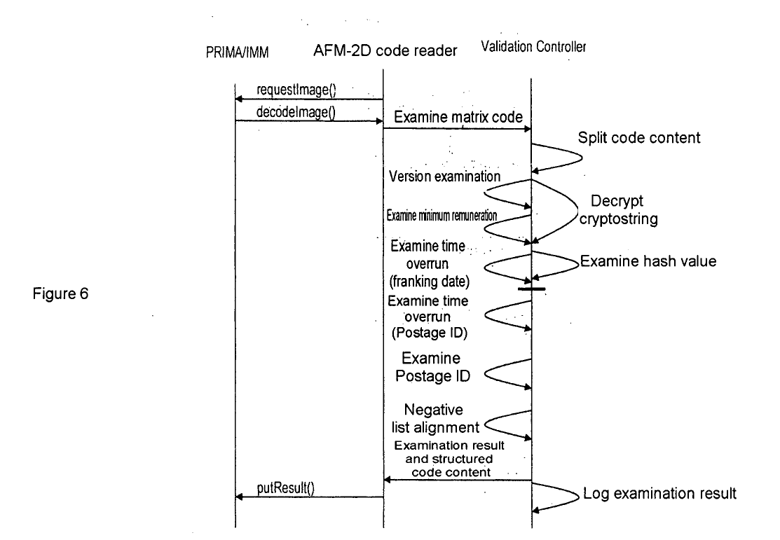

FIG. 6 shows another particularly preferred embodiment of the verifying method with a particularly preferred sequence of examination components;

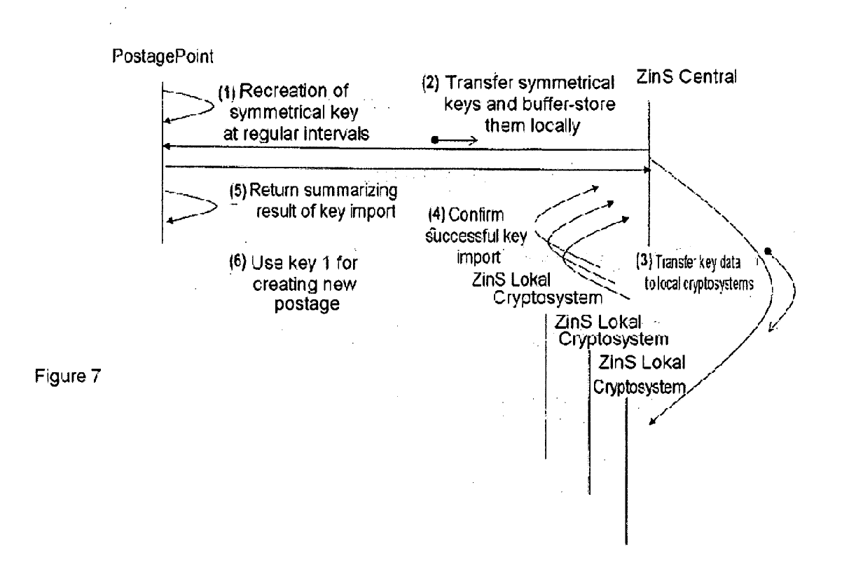

FIG. 7 shows a preferred sequence for distribution of keys between a central loading station (Postage Point) and individual cryptographical verifying units (Crypto Server).

The invention is illustrated below using the example of a PC franking system. In this case, the method steps used for remuneration protection are independent of the system used for producing the franking marks.

The local verify at individual inspection stations, particularly in mail centers, which is shown is particularly preferred, although centralized verifying is equally possible.

In a first embodiment of the invention, the authenticity of the franking marks is preferably verified on a random sample basis by individual scanners.

A verifying system suitable for this purpose preferably contains the components shown in FIG. 1.

FIG. 1 shows to which subsystems the crypto system is related. These are described in brief below.

Scanner

The scanners are used for reading in the franking mark from the PC franking facility. The franking marks are 2D codes in the data matrix format, with the ECC200 error correction used. Depending on scanner type, the data are transferred by radio or by cable, with the radio scanners having a multiline display and hence an output capability and a touchscreen, or a keypad for rudimentary input. The interface between the scanners and the remaining systems of the preferred remuneration protection PC franking system is formed by the scanner controller and the validation controller as components. While the scanner controller manages a queue of matrix codes which emanate from the hand-held scanner, are available for examination and essentially maintain contact with the scanners, it is in contact with the further system only via the validation scanner.

Scanner Controller/Validation Controller

Scanner controllers, or validation controllers, serve as interface between the scanners and the further systems for verifying the 2D barcodes. They are sent the error-corrected 2D barcode content converted from the optical recording, and they then prompt the verify and, in the case of the radio scanners, ensure output of the reading and examination result and serve as an interface between any necessary manual finishing operations and examinations by the examiner and the remaining systems.

Crypto System

The crypto system provides for the content and cryptographical verifying of the 2D barcode content and also for the protected storage of security-related data and algorithms. The individual components will be discussed at a later point.

Charge Sum Loading Station (Postage Point)

The charge sum loading station (Postage Point) is the central system within the PC franking facility. It serves as an interface to the customer systems. From it, the customers can offload preset sums for subsequent franking. The charge sum loading station (Postage Point) is used to generate the keys for protecting the method. In addition, it is used as an interface to the billing systems. The interfaces below are provided for the preferred remuneration protection system for PC franking:

Mailing information by the 2D barcode

Symmetric keys

Master data, such as preset amounts, account balances

Preferred Remuneration Protection Central

In the preferred remuneration protection central system, the mailing-related information is collected and made available to other systems. This is where the production reports are created, which in turn result in the creation of the negative files. In addition, the remuneration protection central system receives from the charge sum loading station (Postage Point) the current key data and forwards these data to the individual crypto servers.

Data Suppliers

To verify the content of the 2D barcodes, a series of master data are required, such as negative files, minimum remunerations, validity periods in relation to the product and remuneration protection warning and follow-up processing codes. These data are provided from different systems (BDE, VIBRIS, local remuneration protection system).

Remuneration Protection Application

The remuneration protection application provides the AGB examiner, who needs to finish the discharged PC franking mailings, with the opportunity to perform a more detailed verification on the franking, with the presentation of the examination results not being restricted by limited output options from the scanner. In addition, the examiner can in this case also inspect other data, such as the validity period for the carriage sum, to which the current mail piece relates and also the amount and the frankings used.

Automatic Recording of the 2D Barcodes

The 2D barcodes are automatically recorded within the SSA. To this end, the image information is forwarded to the AFM-2D code reader. There, the image is converted into the content of the data matrix code. Next, the 2D barcode content is transmitted to the crypto system for examination, the returned examination result is evaluated and is transmitted to the optical recording system (IMM) for the purpose of coding the mail piece. Preferred parts of a verifying method extended in this manner are shown in FIG. 2.

AFM-2D Code Reader

Through each reading machine (ALM/ILVM), there is an AFM-2D code reader which receives the image data of the mail piece via an optical recording system (IMM) and processes them further for remuneration protection purposes. Within the context of preferred remuneration protection PC franking, this means, when a 2D code has been identified, that the 2D data matrix code is extracted from the image data and is converted, using the ECC200 error correction method, into a byte string which represents the content of the 2D barcode.

This byte string is transferred to the validation controller for the purposes of verifying. The examination result is then forwarded via the interface in the optical recording system, where it is used for coding.

Crypto System for AFM 2D Code Reader

Depending on the properties of the crypto cards, approximately 27 examinations per second can be expected, by way of example. Since the rate of the reading machines is approximately 10 mail pieces read per second, it appears pointless to combine each of the AFM-2D code readers with a crypto system. Added to this is the fact that it also cannot be assumed that PC F dispatches are produced on all machines simultaneously to a hundred percent. It therefore appears appropriate to separate the crypto systems and to operate a plurality of PC-F-readers with one crypto system. In this case, the solution should be chosen such that it can be scaled, that is to say a plurality of crypto systems per mail center are possible. This is relevant, by way of example, to mail centers having a high volume of dispatches and a large number of reading machines, which can initially be provided with a second crypto system. In addition, it is later possible to increase the number of servers during operation as the need arises.

In this context, to reduce complexity, the architecture can preferably be chosen such that the individual reading machines are firmly associated with one crypto system and may also be extended by an additional fallback configuration, which attempts to switch over to another crypto system in the event of a fault.

Separating crypto system and AFM-2D code reader also affords the advantage that both machine reading and hand-held scanner examination can be performed using the same crypto system, and therefore the same function does not need to be implemented in duplicate, which additionally also affords significant advantages when implementing the invention.

Preferred method steps for providing a mail piece with a digital franking mark after a charge sum has been loaded from a central loading station (Postage Point) and the franking mark has been produced by a local PC and also the mail piece has subsequently been delivered and the franking mark put on the mail piece has been verified are shown in FIG. 3.

Regardless of the key distribution, the sequence is performed in such a way that a customer first loads an amount of postage onto his PC. To identify the request, a random number is generated in this case. The charge sum loading station (Postage Point) produces a new postage for the respective customer, and the random number transmitted is used to create with further information relating to the identity of the customer system (the customer system identification statement, subsequently called Postage ID), and to the postage the “crypto string”, which is encrypted using a secret symmetrical key existing on the charge sum loading station (Postage Point).

This crypto string and the corresponding postage are then transferred to the customer PC and are stored, together with the random number, in the customer PC's “safe box”, safe from unwanted access.

If the customer franks a mail piece with the postage received following this procedure, then the mailing data relevant to the 2D barcode, inter alia the crypto string, franking date and franking sum, are extended by the random number, and the Postage ID is collected in unencrypted form and a hash value is created which clearly identifies the content.

Since the random number is in encrypted form within the crypto string and also is in unencrypted form within the hash value, it is ensured that the mailing data cannot be altered, or generated arbitrarily, and it is possible to infer the creator.

The relevant data for the mail piece are then subsequently converted into a 2D barcode and are printed onto the mail piece as a corresponding franking characteristic by the customer's printer. The finished mail piece can then be put into mail circulation.

In one particularly preferred embodiment of the remuneration protection, the 2D barcode is read and subsequently verified in the mail center by an AFM-2D code reader, or by a hand-held scanner. The associated process steps become clear in the illustration under operation numbers 5-8. To verify the correctness of the 2D barcode, the AFM-2D code reader transfers the full mailing data to the crypto system. There, cryptographical information contained in the mailing data, particularly information associated with the crypto string, is decrypted in order to ascertain the random number used when creating the hash value.

Next, a hash value (also called Message Digest) is ascertained for the mailing data including the decrypted random number, and a verification is carried out to determine whether the result is identical to the hash value contained in the 2D barcode.

In addition to the cryptographical validation, further content examinations are also performed (operation number 7b) which, by way of example, prevent duplicate use of a 2D barcode or examine whether the customer has been conspicuous on account of attempts at deceit and is therefore listed in a negative file.

The corresponding examination result is then transmitted to the PC-F reader, which forwards the result to the optical recording system (IMM) for coding the barcode. The barcode is then printed onto the letter and the mailings are discharged in the event of a negative examination result.

Crypto System Architecture:

Component Overview

FIG. 4 gives an overview of the subcomponents of the crypto system, with the labeled arrows representing input and output data streams for external systems. Since the preferred remuneration protection central system is used as a turntable when distributing the keys from the charge sum loading station (Postage Point) to the crypto systems in the local remuneration protection systems, and these data need to be buffer-stored, a crypto system component likewise needs to be provided there but generally does not involve the use of the validation controller.

The subcomponents of the crypto system are described in more detail below.

Validation Controller

The validation controller is the interface for verifying the full 2D barcode content. The verification of the 2D barcode comprises a content verification and a cryptographical verification. To this end, the 2D barcode content read in from the scanners should be forwarded to the validation controller by the scanner controller.

Since the responsible scanner controller for the wired scanner and the validation controller are on different computer systems, it is necessary to provide TCP/IP based communication between them, with the use of a protocol based thereon instead of pure socket programming affording advantages. Within the context of the crypto system, the message manager used within operational data recording (BDE) or the protocol used within the scope of the optical recording system, such as Corba/IIOP, are suitable in this case.

The validation controller initiates the individual examination routines, which in turn transmit their examination results back to it.

Since a plurality of AGB examiners with different scanners become active at the same time, the validation controller needs to be designed to have “multisession capability”. That is to say it has to be able to prompt simultaneous examination requests and to direct the corresponding output to the correct scanner. In addition, it should be designed such that it can simultaneously execute a plurality of examination requests and also some of the examination steps, for example hash value examination and minimum remuneration examination, in parallel therewith.

At the start of a session, the controller is notified of the type of scanner with which it is communicating, and it is assigned an opportunity, by callback method, to actuate routines for output and for manual reexamination. Depending on mode of operation and scanner type, the results are then output either on the radio scanner or on the remuneration protection system, and also manual examination results are recorded.

Crypto Card

One particular problem area is keeping the key which needs to be used for encrypting the crypto string in a 2D barcode and for decrypting it again for examination purposes. This key ensures that the 2D barcodes are protected from corruption, and it must therefore not be possible to obtain it by spying. It is therefore necessary to use special security measures to ensure that this key is never visible in plain text on the hard disk, in the memory or upon transfer and is additionally protected by powerful cryptographical methods.

Purely software based solutions do not provide reliable security in this case, since at some point in the system a key actually appears in plain text, or the key could be read in plain text from the memory using a debugger. This risk also exists particularly on account of the fact that the systems can be administered remotely, or may leave the company for the purpose of repair.

In addition, the cryptographical methods produce a high load on the system's processor, which is not optimized for the operations which are to be performed.

The use of a crypto processor card having the following characteristics can therefore be recommended:

special crypto processor for accelerating cryptographical methods

a sealed black box system for preventing access to security-critical data and methods.

The cards satisfying these characteristics are autarkic systems which, depending on form, are connected to the computer via the PCI bus or the ISA bus and communicate with the software systems on the computer via a driver.

Besides a battery-buffered main memory, the cards also have a flash ROM memory in which it is possible to store an individual application code. Direct access to the main memory on the cards is not possible from the external systems, which means that a very high level of security is ensured, since neither the key data nor the cryptographical methods for providing the security can be used other than via the protected driver.

In addition, the cards use dedicated sensors to monitor whether manipulation attempts are being made (depending on card design, for example temperature spikes, radiation, opening of the protective cover, voltage spikes).

If such a manipulation attempt is being made, then the battery-buffered main memory content is immediately erased and the card is shut down.

For the crypto server, the function for decrypting the Postage ID, the function for examining the hash value and also the function for importing key data should be loaded directly onto the card; since these routines have a high security relevance.

Furthermore, all cryptographical keys and also the configurations of certificates which are necessary for performing the authentication should likewise be saved in the card's battery-buffered memory. If the card does not have sufficient memory, then the card usually holds a master key which can be used to encrypt the data listed above and then to store them on the system's hard disk. However, this requires that use of this information first be preceded by decryption of the data again.

The table below gives an overview of the suitable card models from different manufacturers and simultaneously states their certifications.

Crypto cards for use within the preferred remuneration protection system for PC franking

| Manufacturer | Type descriptor | Certification |
|---|---|---|
| IBM | 4758-023 | FIPS PUB 140-1 |
| | | Level 3 and ZKA- |
| | | eCash |
| IBM | 4758-002 | FIPS PUB 140-1 |
| | | Level 4 and ZKA- |
| | | eCash (prob. |
| | | 07/2000) CCEAL 5 |
| | | (attempted, |
| | | currently in |
| | | certification |
| | | phase) |
| Utimaco | Crypto Server | ITSEC-E2 and ZKA- |
| | | eCash |
| Utimaco | Crypto Server | FIPSPUB 140-1 |
| | 2000 | Level 3, |
| | (available | ITSEC-E3 and ZKA- |
| | approx. 1Q/01) | eCash (attempted) |
| Racal/Zaxus | WebSentry PCI | FIPS PUB 140-1 |
| | | Level 4 |

Besides satisfying the requirements made of the card, the desired BSI certification means that it is also very important what certifications the individual models currently have and what certifications are currently in the evaluation process.

In this case, certificates issued for the products are divided into the three classifications made by different certification stations.

The ITSEC is a criteria mechanism published by the European Commission for the purpose of certifying IT products and IT systems with regard to their security properties. The assessment of trustworthiness is based on levels E0 to E6, where E0 denotes inadequate security and E6 denotes the highest security. Further development and harmonization with similar international standards are the CCs (Common Criteria) currently in a standardization process at the ISO (ISO standard 15408). This control mechanism is used to assess the security of the system.

There is currently still no product from the above table which has a certificate in line with CC. However, the IBM model 4758-002 is currently in such a certification phase.

The standard FIPS PUB 140-1 is a criteria act issued by the American government for the purpose of assessing the security of commercial cryptographical equipment. This criteria act is oriented very greatly to hardware properties. The assessment is made at four levels, where Level 1 signifies the least security and Level 4 signifies the highest security.

In addition to the aforementioned assessment standard, there is a further criteria act which is issued by the Central Credit Committee (ZKA) and controls licenses for operating IT systems and products in the area of electronic cash.

Besides the aforementioned properties of the cards and the allocated certifications, however, there is also a series of further advantages, which are listed briefly below:

creation of own (signed) software and upload to the card possible

integrated random number generator (FIPS PUB 140-1 certified)

DES, Triple DES and SHA-1 implemented on the hardware side

RSA key production and private/public key—processing for keys up to 2048 bits in length

key management—functions

certificate management—functions

to some extent operation of a plurality of crypto cards in parallel possible in one system

Crypto Interface

The functions relating to security within the context of the crypto card application are stored directly in the card and are therefore externally accessible only using the card driver. The interface used between the driver and the validation controller is the crypto interface component, which forwards the requests for examination routines using the driver to the card.

Since it is possible to use a plurality of cards within one computer, the task of the crypto interface is also to perform load distribution for the individual examination requests. This function is expedient particularly when, additionally, the examination routines of the crypto system are used by another or, depending on the mail center, a plurality of AFM-2D code reader(s).

Another task is the handling of communication for the purpose of distributing the key data. At level 2, there may exist just a rudimentary mechanism which transfers the keys encrypted for security purposes within a signed file. A request to the crypto interface then involves providing a utility which allows such a file to be imported.

Functions of the Crypto System

Sequence of the Examination in the Validation Controller

To examine the 2D barcode, the validation controller provides a central examination function as an interface to the scanner or reading systems. This examination function coordinates the sequence of the individual examination components.

The codes transmitted from the individual examination routine components for the remuneration protection incident are converted to the appropriate remuneration protection code using a predefined table which is preferably maintained centrally and is transferred to the crypto system. Within this table, priorities are additionally stipulated which regulate which remuneration protection code is allocated when a plurality of remuneration protection incidents have been recognized.

This remuneration protection code is then returned as an examination result together with a descriptive text. Depending on the system performing further processing outside of the crypto system, this result is then output on the radio scanner or within the remuneration protection application, or is converted into a TIT2. code during the automatic examination and is printed onto the mail piece.

Since the sequences between the hand-held scanner systems and the automatic reading systems are different, a different function is implemented for the two instances of application.

The call and the return of the results differ according to which communication mechanism is used between the reading system and the validation controller. If a synchronous RPC based protocol such as Corba/IIOP is used, the examination method is called directly and the examination results are transferred when the examination has finished. The client, that is to say the scanner controller, and the reading system then wait for implementation and return of the examination results. For the latter, it is therefore necessary to provide the client with a thread pool, which can perform parallel examination on a plurality of requests.

In the case of the asynchronous mechanism using TGM, the scanner controller, or the reading system, does not call the examination method directly, but rather a message is sent to the crypto system which contains the examination request, the content of the 2D barcode and further information, such as current sorting program. Upon receipt of this message on the crypto system, the examination function is called, executed and the reading and examination results are in turn returned as a new message. The advantage with this method is that the process is not blocked on the requesting system until the result is available.

Examination for Hand-Held Scanner Systems:

The examination routine for the hand-held scanner systems awaits the session ID and also the content of the 2D barcode as input values. As an additional parameter, the ID of the sorting program is also awaited. The latter parameter is used to determine the minimum remuneration.

FIG. 5 shows an overview of the sequence of the examination within the validation controller for the instance in which said examination has been triggered by a hand-held scanner system. In this case, the assumption is an examination using a radio scanner with subsequent manual comparison of the address with the 2D barcode content. In the case of a wire-connected scanner, the presentation would be made in a similar manner on the remuneration protection system, or on the remuneration protection application.

A preferred verifying sequence using a radio scanner, a scanner controller and a verifying unit (validation controller) is illustrated in FIG. 5.

In the particularly preferred exemplary embodiment illustrated, the verifying unit controls a sequence of examination components, with the first examination component comprising reading-in of a matrix code held in the digital franking mark. The matrix code which has been read in is first transferred from a radio scanner to a scanner controller. Next, the scanner controller's domain examines the matrix code and transmits it to the verifying unit. The verifying unit controls the splitting of the code content. The reading result is then transmitted to the recording unit—in the case illustrated a radio scanner. As a result, a user of the reading unit finds out, by way of example, that it has been possible to read the franking mark and in so doing to recognize the information contained in the matrix. Next, the verifying unit encrypts a crypto string contained in the matrix code. To this end, the version of the key probably used for creating the franking mark is preferably verified first of all. The hash value contained in the crypto string is then tested.

In addition, the minimum remuneration provided is examined.

Furthermore, an identification number (Postage ID) for the customer system controlling production of the franking mark is verified.

Next, the identification number is brought into line with a negative list.

These verifying steps make it possible, in this particularly simple and expedient form, to ascertain franking marks produced without authorization in a simple manner.

The result of the transmission is transmitted as a digital message, the digital message being able to be transmitted to the original radio scanner, for example. As a result, a user of the radio scanner can remove the mail piece from the mailing cycle, for example. In the case of automated implementation of this method variant, however, it is naturally equally possible to remove the mail piece from the normal processing cycle of mail pieces.

Preferably, the result of the examination is logged in the verifying unit's domain.

As a return value, the code belonging to the remuneration protection incident and the associated text message and also the 2D barcode object should be returned.

Examination Sequence with AFM-2D Code Reader

The input parameter awaited for the examination routine for the AFM-2D code reader is likewise the session ID, and also the content of the 2D barcode and the unique identifier of the sorting program which is currently active.

FIG. 6 shows an overview of the sequence of the examination within the validation controller when said examination has been triggered by a reading system.

To illustrate the sequence, the figure also shows, additionally, the optical recording system (IMM system) and also the AFM-2D code reader, in order to illustrate the overall context of the examination. However, the part of the crypto system is limited to examining the functions between 2D barcode and the return and also the logging of the result.

In the case of the message manager interface, the validation controller would start a plurality of service tasks which would await examination request messages and would use the message content to call the examination routine. The result of the examination routine is awaited and is packed into a message and is returned to the requesting client.

FIG. 6 shows a further preferred embodiment of control of a sequence of examination components by the verifying unit (validation controller). In the case of this further preferred embodiment, the franking marks are recorded by an automatic optical recognition system (Prima/IMM). The data are from the optical verifying unit to a reading and recording unit (AFM-2D code reader).

In the case of the embodiment shown in FIG. 6 for the method for verifying the validity of digital franking marks, the digital franking marks are read in preferably in an even more highly automated manner, for example through optical recording of a station for a mail piece on which a franking mark is preferably arranged. The further verifying steps are performed essentially in line with the examination sequence shown by FIG. 5.

The return value for the examination routine firstly comprises the remuneration protection code and an associated message and also the converted content extended by the Postage ID. These return values are used to produce a message and to transmit it to the requesting reading system.

Content Examinations

Split and Reshape 2D Barcode Content

Input: scanned 2D barcode

Description:

In this function, the 80-byte content of the 2D barcode needs to be split and converted into a structured object, subsequently referred to as 2D barcode object, in order to achieve a better display opportunity and also more efficient finishing. The individual fields and conversions are described in the table below:

When converting the binary numbers into decimal numbers, it should be remembered that the left-hand byte of a byte sequence is the most significant byte. If it is not possible to convert, possibly on account of a type conflict or missing data, then it is necessary to generate a remuneration protection incident message “PC-F barcode illegible” and to return it to the validation controller. A further content or cryptographical verification is not appropriate in this case.

| | | To be converted | |
|---|---|---|---|
| Field | Type | to | Description |
| Mail company | ASCII | | No conversion |
| | (3 bytes) | | necessary |
| Franking type | Binary | Small integer | |
| | (1 byte) | | |
| Version | Binary | Small integer | Version number |
| characteristic | (1 byte) | | of the method |
| Key No. | Binary | Small integer | Key type |
| | (1 byte) | | |
| Crypto string | Binary | | Byte sequence |
| | (32 bytes) | | to be |
| | | | transferred |
| | | | unchanged, |
| | | | following |
| | | | decryption the |
| | | | postage ID is |
| | | | split off |
| Postage ID | | Text (16 | Will be filled |
| | | characters) | following |
| | | | decryption of |
| | | | the crypto |
| | | | string |
| Serial | Binary | Integer | Positive |
| dispatch | (3 bytes) | | numbers only |
| number | | | |
| Product key | Binary | Integer | Positive |
| | (2 bytes) | | numbers, |
| | | | reference to |
| | | | associated |
| | | | reference table |
| Remuneration | Binary | Float | Conversion to |
| | (2 bytes) | | positive |
| | | | decimal number |
| | | | which can be |
| | | | divided by 100, |
| | | | indicated in |
| | | | euro |
| Franking date | Binary | Date | Following |
| | (3 bytes) | | conversion to |
| | | | positive |
| | | | decimal number, |
| | | | the date can be |
| | | | converted |
| | | | according to |
| | | | the format |
| | | | YYYYMMDD |
| Receiver zip | Binary | 2 values, one | Following |
| code | (3 bytes) | for country, one | conversion to |
| | | for zip code | positive |
| | | | decimal number, |
| | | | the first two |
| | | | digits give the |
| | | | country code, |
| | | | and the last |
| | | | five digits |
| | | | give the zip |
| | | | code |
| Road/mailbox | ASCII | Road | If the first |
| | (6 bytes) | abbreviation or | digits are |
| | | mailbox | numbers, then a |
| | | | zip code has |
| | | | been coded, |
| | | | otherwise the |
| | | | first and last |
| | | | three |
| | | | characters of |
| | | | the road with |
| | | | house number |
| Carriage | Binary | Float + currency | Following |
| remainder sum | (3 bytes) | field (text 32 | conversion to a |
| | | characters) | positive |
| | | | decimal number, |
| | | | the first digit |
| | | | gives the |
| | | | currency |
| | | | (1 = euro), the |
| | | | next four |
| | | | digits give the |
| | | | digits before |
| | | | the decimal |
| | | | point and the |
| | | | remaining two |
| | | | digits give the |
| | | | digits after |
| | | | the decimal |
| | | | point |
| Hash value | Binary | | Byte sequence |
| | (20 bytes) | | needs to be |
| | | | transferred |
| | | | unchanged, used |
| | | | for |
| | | | cryptographical |
| | | | validation of |
| | | | the franking |

Return value: 2D barcode object Warning code 00 if conversion OK, otherwise warning for remuneration protection incident “PC-F barcode illegible”

Version Number Examination

Input: current 2D barcode object

Description:

The first three fields reveal the version of the 2D barcode. From this, it can also be seen whether the franking mark is actually a 2D barcode associated with Deutsche Post and not a 2D barcode associated with another service provider. The field contents need to be compared with a list of valid values which has been preconfigured in the application. If no match is found, then a remuneration protection warning “PC-F version” is returned. Verifying further content and cryptographical aspects is then pointless and should not be pursued.

Return value: Warning code 00 if version examination OK, otherwise warning code for remuneration protection incident “PC-F version”

Verify Postage ID

Input: 2D barcode object with decrypted Postage ID

Description:

The Postage ID contained in the 2D barcode is protected by an examination digit method (CRC 16) which needs to be verified at this point. Should this verification fail, then the result which needs to be returned is a remuneration protection warning “PC-F corruption suspected (Postage ID)”. Verifying the Postage ID requires the prior decryption of the crypto string.

Return value: Code “00” if examination OK, otherwise warning code for remuneration protection incident “PC-F corruption suspected (Postage ID)”

Examination of Time Overrun

Input: 2D barcode object

Description:

This function is used for automatically verifying the time interval between franking of a PC franked mail piece and processing thereof at the mail center. Only a particular number of days is permitted to lie between the two dates. In this case, the number of days is based on the product and its transfer times plus one day's wait.

The configuration of the period is preferably stored in a product validity period relation and is maintained centrally within the context of a maintenance mask. For each product key possible for PC franking (2D barcode's field), the relation stores the associated number of days which are permitted to lie between franking and processing at the mail center. In a simplified method, just one period statement is preconfigured, which relates to standard dispatches and is stored as a constant in the system.

For verifying purposes, the number of days between the current test date during the processing and the date contained in the 2D barcode is formed, for example 08.02. to 08.01.=1 day. If the ascertained number of days is greater than the value prescribed for the product, then the remuneration protection code associated with the warning case “PC-F date (franking)” is returned to the validation controller, otherwise a code documenting successful examination is returned. If a simplified method always involves a comparison with the value for standard dispatches, then following output of the examination result it should be possible to correct this examination result, for example manually using a button on the scanner, if the current product permits a longer transfer time.

A further examination of the time overrun relates to the content of the Postage ID. The carriage sum downloaded within the context of a preset, and hence also the Postage ID, have a prescribed validity period in which the dispatches need to be franked. The Postage ID contains the time up to which the carriage sum is valid. If the franking date is a particular number of days greater than this validity date, then the remuneration protection warning code associated with the remuneration protection warning “PC-F date (carriage sum)” is returned.

Return value: Code “00” if examination OK, otherwise warning code for remuneration protection incident “PC-F date (carriage sum)” or “PC-F date (franking)”

Remuneration Examination

Input: 2D barcode object; current sorting program ID

Description:

Within this function, the remuneration contained in the 2D barcode is examined for a minimum remuneration which is defined for dispatches of the associated sorting program. The sums are euro sums.

The associations are delivered between sorting program and minimum remuneration via an automatic interface.

A simplified method can be applied in a similar manner to when examining the time overrun. In this case, the configuration file for the application defines a constant minimum remuneration which applies to all dispatches. It is therefore not necessary to transfer the sorting program.

The subsequent examination involves comparing whether the minimum remuneration contained in the 2D barcode is below this stamp. If this is the case, then the code associated with the remuneration protection incident “PC-F underfranking” is returned, otherwise the success code is returned.

Return value: Code “00” if examination OK, otherwise warning code for remuneration protection incident “PC-F underfranking”

Alignment with Negative File

Input: 2D barcode object with decrypted Postage ID

Description:

Within this function comes the examination to determine whether the Postage ID associated with the 2D barcode is contained in a negative file. The negative files are used to remove from the delivery cycle any mail pieces from customers which have come to light on account of attempts at misuse, or whose PC has been stolen.

In this case, the negative files are maintained centrally as part of the project Database Franking. Within the context of the interface for this project, the method for interchanging the data needs to be determined for the local mail center systems.

If the maintenance application, or the data interchange, possibly does not yet exist, then a changeover mechanism needs to be created in this case. These data could be maintained as part of a changeover in an Excel sheet, from which a csv file is generated. This file should be sent by e-mail to the AGB examiners and should be read into the systems by the latter using an import mechanism which needs to be provided. Later, the transfer is then made via the path defined within the preferred remuneration protection IT fine concept.

A Postage ID characterizes an individual preset which a customer retrieves from the system (Postage Point). These presets are stored in a “safe box” on the customer system. This is a hardware component in the form of a smart card including reading system, or a dongle. The safe box safely keeps the preset sums, and the customer can retrieve individual franking sums therefrom without being connected to the charge sum loading station (Postage Point) online.

Every safe box is characterized by a unique ID. This safe box ID is entered in the negative file if the associated dispatches need to be removed on account of suspicion of misuse. The safe box ID is made up of a plurality of fields. Besides the unique key, the safe box ID also contains further fields, such as validity date and examination digit. For the purpose of uniquely identifying the safe box, the first three fields of the safe box ID are definitive. These are also found in the first three fields of the Postage ID, which means that the association can be made between safe box and preset. The fields are described in the table below:

| | | | Data | |
|---|---|---|---|---|
| Byte No. | Length | Meanings | content | Comment |
| b1 | 1 | Provider | 00 | not used |
| | | identifier | | |
| | | | 01 | Test |
| | | | | provider: |
| | | | | mail piece |
| | | | | company |
| | | | FF | Postage point |
| | | | | box |
| | | | | associated |
| | | | | with the mail |
| | | | | piece company |
| b2 | 1 | Licensed | xx | To be used |
| | | model No. | | for every |
| | | | | manufacturer, |
| | | | | rising from |
| | | | | 01 (first |
| | | | | submitted |
| | | | | model), for |
| | | | | every newly |
| | | | | licensed |
| | | | | model. |
| b3, b4, | 3 | Serial | xx xx xx | To be used |
| b5 | | number of | | for every |
| | | the model | | licensed |
| | | | | model from |
| | | | | every |
| | | | | manufacturer, |
| | | | | rising from |
| | | | | 00 00 01 to |
| | | | | FF FF FF. |

If the first three fields of the Postage ID of the currently examined franking are identical to the first three fields of a safe box ID contained in the negative file, then the remuneration protection incident associated with the customer within the negative file is returned, otherwise the success code is returned.

Return value: Code “00” if examination OK, otherwise warning code associated with the customer, or with the safe box in the negative file

Comparison of 2D Barcode Content with Mailing Plain Text

Input: 2D barcode object

Description:

To prevent it from being possible to make copies of 2D barcodes, a comparison is made between the dispatch data coded in the 2D barcode and the data indicated in plain text on the letter. This comparison is directly possible on the radio scanners, since these have sufficient display and input options. In the case of the hand-held scanners with a wire connection, the examination needs to be performed on the PC (remuneration protection system).

The appearance of the sequence is that the validation controller prompts output of the data in the 2D barcode on the radio scanner, or on the remuneration protection PC, after the automated examinations have run. To this end, the validation controller has a callback method available which is allocated at the start of a session.

The validation controller calls up this callback method using the current 2D barcode object. The scanner controller, and the remuneration protection PC, are then responsible for displaying the 2D barcode content and return a “00”, or an associated error code, as the return value (after being processed by the examiner) for the callback method.

If evaluation is successful, the success code is returned, otherwise the code of the remuneration protection warning “PC-F plain text” is returned.

In the case of an automatic examination, this examination is not necessary. In this case, the examination can preferably be performed within the context of the central evaluations offline either using turnover comparisons or using a comparison between the target zip code and the zip code contained in the 2D barcode.

Return value: Code “00” if examination OK, otherwise warning code for remuneration protection incident “PC-F plain text”

Cryptographical Examinations

The cryptographical examination comprises two parts:

a) a decryption of the crypto string and

b) the hash value comparison.

Both methods need to be carried out in the protected area of the crypto card, since a customer could produce valid franking hash values if spying on the information produced during processing.

Decrypt Crypto String

Input: 2D barcode object

Description:

As input parameter, this function receives the split 2D barcode object from the scanner result. The franking date and the key number are used to search for the symmetrical key valid for this time, and the transferred object's crypto string is decrypted using this key in accordance with the Triple DES CBC method. What value needs to be put into the initialization vector, and whether innerbound or outerbound CBC and what block length is used, is decided within the context of the interface to the remuneration protection system.

Should the key contained in the 2D barcode not be available on the crypto system, then the remuneration protection warning “PC-F corruption suspected (key)” is returned with the error message that the key was not found using the key number.

The result of the operation comprises the decrypted Postage ID, and also the decrypted random number. The decrypted Postage ID is entered in an appropriate field in the 2D barcode object. The random number should not be disclosed for security reasons, since the customer could produce valid hash values and hence could corrupt 2D barcodes if he had this information.

Following the decryption, the hash value calculation is called from the method and its return value is returned.

Hash Value Calculation

Input: 2D barcode object decrypted random number from the crypto string (the decrypted random number must not be known outside of the card)

Description:

The hash value calculation function ascertains the first 60 bytes from the original scan result contained in the 2D barcode object. This has the decrypted Postage ID and also the transferred decrypted random number appended to it. The SHA 1 method is used to calculate a hash value therefrom and said hash value is compared with the 2D barcode's hash value contained in the 2D barcode object. If all 20 bytes match, the cryptographical verification is successful, and a corresponding return value is returned.

If there is no match, a remuneration protection warning “PC-F corruption suspected (hash value)” is returned to the validation controller.

As return value, the calculated hash value is additionally transmitted so that it can also be output for the examination result.

Return value: Calculated hash value Code “00” if examination OK, otherwise warning code for remuneration protection incident “PC-F corruption suspected (hash value) ” or “PC-F corruption suspected (key)”

Result Output

Present examination and reading result

Description:

A callback method provides the validation controller with the opportunity to control a result output on the output unit associated with the current examination. To this end, the validation controller transfers the 2D barcode object and the ascertained remuneration protection warning code to this callback method. The return value delivered can be the code of the finishing method selected by the AGB examiner.

The callback method for the output is, likewise at the start of the session, assigned when registering on the validation controller.

Result Logging

Input: 2D barcode object, code of the examination result

Description:

In a simplified method, the result logging takes place in a file on the system on which the validation controller is running. Normally, the results, or sets of directions, are transmitted directly to BDE and are written to the database in the preferred local remuneration protection system via the preferred remuneration protection BDE interface.

Preferably, the Postage ID, the serial number, the franking date, the postage, the product key, the zip code, the remuneration protection result code, the message text, the length of the examination, the time of the examination, the scanner's ID, the scanner's mode of operation, the recording mode, and also the type of further processing are stored. All values are output, separated from one another by a semicolon, in one respective set per mail piece and can be evaluated further in this form, for example in Excel.

If the system is in the “initial recording” mode of operation, then an “e” is to be entered in the recording mode column instead of an “n” for subsequent recording.

Provision of Master Data

Description:

A series of master data are necessary for the content verification. These are:

PC-F negative file

sorting programs and minimum remunerations

general minimum remuneration

product key PC-F

maximum delivery time per product key PC-F

general maximum delivery time

remuneration protection incidents, priorities and association with further processing instructions

further processing instructions

Master data can be firmly preconfigured in a changeover time with the exception of the PC-F negative file and also the cryptographical keys for the charge sum loading station (Postage Point).

If necessary, simple processing and distribution applications can be implemented for some of the data. In that case, maintenance should be performed in an Excel sheet, from which a csv file is generated. This file should be sent to the AGB examiner by e-mail and should be read into the systems by the AGB examiner using a mechanism which needs to be provided.

Normally, the data are distributed in line with the method described in the Preferred Remuneration Protection IT fine concept, or access to these data is enabled.

The associated data structures are described in the data model for the Preferred Remuneration Protection fine concept.

Distribution of the Key Data

The symmetrical keys, which are used on the charge sum loading station (Postage Point) for the purpose of protecting the 2D barcode contents and which are required by the crypto system for validation, are interchanged at regular intervals for security reasons. When used in all mail centers, the keys need to be transferred automatically and safely from the (Postage Point) to the crypto systems.

In this case, interchange should take place via the preferred remuneration protection server, since the charge sum loading station (Postage Point) should not have any configuration regarding which preferred local remuneration protection systems and which crypto systems therefor exist.

Particularly preferred method steps for interchanging keys are shown in FIG. 7. The preferred key interchange takes place between a central loading station (Postage Point), a central crypto server and a plurality of local crypto servers.

Since the symmetrical keys are of great importance for the 2D barcodes' corruption security, the interchange needs to be protected by a high level of cryptography and by explicit authentication of the communicating parties.

Configuration

Basic Configuration/Key Management of the Crypto Hardware

For the crypto card's basic configuration, various measures are necessary. These should be performed by a security administrator. They roughly involve the following activities:

installation of the software API on the card

generation and installation of the private keys for protecting administration applications and loadable software

Depending on the selected card type and card manufacturer, this requires different measures.

The crypto card's application-related basic configuration provided for the preferred remuneration protection system comprises the following steps:

secure encryption and transfer of the symmetrical keys to the card—for example RSA encryption pair —with simultaneous certificate generation for the public key and output of the key

firmly preconfigure a certificate for the charge sum loading station (Postage Point) in order to ensure that the key to be imported has been issued by the charge sum loading station (Postage Point).

Basic Configuration of the Crypto System Application

Every scanner, every user and every crypto card within the crypto system needs to be characterized by a unique ID. Ultimately, it is also necessary to identify every AFM-2D code reader by means of a unique ID.

Login/Logoff

At the start of a session with the validation controller, there needs to be a login. As parameters, this login contains the scanner ID, the user ID and also the callback methods for the manual examination, or the output of the reading and examination results.

The return value returned is a session ID which also needs to be transferred upon subsequent examination calls within the session. For the session ID, a session context is stored on the validation controller, said session context storing the transfer parameters.

If, during his session, the user makes changes to the mode of operation, to the predefined product, or to other session settings which can be configured during the runtime, then these changes are reconstructed in the variables allocated for this purpose within the session context.

For a logoff, the session context is deleted as appropriate. Subsequent examination calls with this session ID are rejected.

The management of users and passwords needs to be defined in a general user management concept for preferred remuneration protection, which is part of the preferred remuneration protection IT fine concept.

The reading systems need to be registered with the validation controller before examination requests are executed. The parameters to be transferred are the reading system's ID and also a password. The return value returned upon successful registration is likewise a session ID, which needs to be transmitted upon the subsequent verification requests.

When the reading system is shut down, there needs to be a corresponding logoff with this session ID.

Miscellaneous

Special User Roles

Within the context of the security concept, two special user roles need to be provided, which need to be performed by two different people.

Security Administrator

The role of security administration comprises the following tasks:

creating command files for administering the crypto card

signing these command files

initializing and managing the crypto cards

supervising the loadable software and the associated configuration

The security administrator authenticates himself using the private key for card administration. This is stored on a diskette or smart card and needs to be kept strictly locked away by the security administrator.

Only administration commands signed using this key can be executed on the crypto card. Since this mechanism protects the command sequence and the associated parameters, execution of these commands can also be delegated to system administrators in situ. To this end, the security administrator needs to make the commands available and to write appropriate method instructions.

Another task is management of the crypto cards, with the serial number, the configuration and the system number of the system in which these cards are installed, and also the location of the system being recorded for every card. For the reserve crypto cards, there is also a record of who is holding the cards.

Together with the security manager QA, he supervises the software sources and the associated software configuration and enables them for installation.

In addition, the software which needs to be installed, or is installed, on the card and on the crypto server is examined and also the card software is enabled and signed.

The card software specifically needs to be examined to determine whether at any point one of the secret keys can be passed to the outside via the driver interface, or whether manipulation attempts have been made there, such as storage of constant predefined keys or the use of nonsecure encryption methods. In addition to the card software, it is also necessary to examine the crypto server's application software which is linked to said card software.

Authentication is performed in exactly the same way as in the case of the security administrator using a private key. In this case, however, the private key for software signing is involved.

However, an additional security in this case involves installation of the software requiring not just that the software be signed, but also the associated installation command. Since two different people (QA manager and security administrator) are responsible for this, and since the associated keys are kept at two different locations, a high level of security is likewise ensured in this case.

The software is distributed by the security QA manager in agreement with the security administrator.

This particularly preferred embodiment of the invention thus provides two different authentication keys, which means that data security is increased considerably.

1. A method for verifying the authenticity of a digital franking mark which has been put on a mail piece, with cryptographical information contained in the franking mark being decrypted and used for verifying the authenticity of the franking mark, the method comprising the steps of:
controlling a sequence of examination components with a verifying unit, and with a first examination component comprising the step of reading-in a matrix code contained in the digital franking mark,
controlling a splitting of the content of the matrix code with the verifying unit,
carrying out the examination components as examination steps,
simultaneously executing a plurality of examination requests with the verifying unit and carrying out some of the examination steps in parallel therewith,
ascertaining franking marks produced by the examination steps without authorization.
transmitting the verification as a digital message, and
discharging a mail piece from the normal processing cycle for the mail pieces as a result of the digital message.

2. The method in of claim 1, wherein one of the examination components comprises of decrypting the cryptographical information contained in the franking mark.

3. The method of claim 1, wherein one of the examination components comprises a comparing the date of production of the franking mark and the current date.

4. The method of claim 1 comprising interchanging information between the reading and the verifying unit using a synchronous protocol.

5. The method of claim 4, wherein the protocol is RPC based.

6. The method of claim 1 comprising communicating between the reading unit and the verifying unit using an asynchronous protocol.

7. The method in of claim 6, comprising the reading unit sending a data message to the verifying unit.

8. The method in of claim 7, wherein the data message contains the information of the franking mark.

9. The method of claim 8, wherein the data message contains a request to start a cryptographical verifying routine.

10. The method of claim 9, comprising performing a load distribution between a plurality of verifying means by a crypto interface.

11. The method of claim 1, comprising splitting the content of the franking mark into individual fields.

12. The method of claim 1, comprising ascertaining an identification number from the franking mark (Postage ID) for the customer system controlling the production of the franking mark.

13. The method of claim 1, comprising recording individual customer system identification specifications (Postage ID) in a negative file, and discharging the mail pieces associated with this Postage ID from a normal processing progression for mail pieces.

14. The method of claim 1, comprising comparing an encrypted receiver address statement contained in the franking mark with a receiver address indicated for delivery of the mail piece.

15. The method claim 1, comprising changing verifying parameters for the method.

16. The method of claim 15, comprising changing the method parameters only after inputting a personal digital key (private key) associated with a system administrator.
